(19) United States
(12) Patent Application Publication
(10) Pub. No.: US 2015/0288627 A1
(43) Pub. Date: Oct. 8, 2015

(54) CORRELATING ELECTRONIC MAIL WITH MEDIA MONITORING

(71) Applicant: Google Inc., (US)

(72) Inventors: Simon Michael Rowe, Berkshire (GB); Nicholas Salvatore Arini, Southampton (GB)

(21) Appl. No.: 13/801,223

(22) Filed: Mar. 13, 2013

(51) Int. Cl. H04L 12/58

(52) U.S. Cl. CPC H04L 51/00

(57) ABSTRACT

A system and method for correlating electronic mail (email) with media monitoring is provided. The system includes a data store with a computer readable medium storing a program of instructions for the correlation of email with media monitoring; a processor that executes the program of instructions; an email retrieval unit to retrieve a plurality of emails; an email analyzer unit to analyze the plurality of emails to determine which of the plurality of emails are a receipt; an email extracting unit to extract relevant data from the plurality of emails that area analyzed as a receipt; and a correlation detection unit to determine if the extracted relevant data corresponds to any data associated with the media monitoring.

### BACKGROUND

A measurement system monitors media consumption habits by a media consumer. Thus, by being cognizant of the media consumption habits, a content provider may effectively determine if certain media displayed at certain times is effective at directing the media consumer to purchase a good or service associated with the media. Media consumption may refer to viewing a program, listening to an audio program, accessing a web site, for example.

In addition to the primary media consumed by the media consumer, shared content may also be served to the media consumer. The shared content may include information about goods or services. The shared content may include meta information, thereby allowing the media consumer to electively access the meta information to access a web site to learn more about the good or service associated with the shared content.

The measurement system may be implemented at a single source, such as a television or a personal computer. Further, the measurement system may be equipped with an ability to log a specific media consumer associated with media consumption for a time period. The measurement system may log the media consumption habits of a specific media consumer by prompting the specific media consumer to manually submit to a login process. Alternatively, the metering system may automatically login each specific media consumer. The metering system may be equipped to detect multiple media consumers' simultaneously consuming media.

Online commerce is increasingly becoming more popular. An e-commerce web site may offer goods or services for purchase. In response to purchasing a good or service, the e-commerce web site may deliver an electronic receipt to the purchaser's email address.

Additionally, a person may go to a physical store. If the person purchases an item at the physical store, the person may elect to avail an email address to operators of the physical store. The operators of the physical store then may deliver an electronic receipt to the person's email.

### SUMMARY

A system and method for correlating electronic mail (email) with media monitoring is provided. The system includes a data store with a computer readable medium storing a program of instructions for the correlation of email with media monitoring; a processor that executes the program of instructions; an email retrieval unit to retrieve a plurality of emails; an email analyzer unit to analyze the plurality of emails to determine which of the plurality of emails are a receipt; an email extracting unit to extract relevant data from the plurality of emails that area analyzed as a receipt; and a correlation detection unit to determine if the extracted relevant data corresponds to any data associated with the media monitoring.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example of a system for correlating email with media monitoring.

FIGS. 3(a)-(c) illustrate examples of an email extraction lookup table, a metering data lookup table, and a correlation lookup table 208, respectively.

FIG. 4 illustrates an example of a method for correlating email with media monitoring.

### DETAILED DESCRIPTION

With respect to known techniques for monitoring media consumption habits, several issues exist preventing or limiting an accurate detection of the effectiveness of the media in encouraging a media consumer to purchase a good or service. A metering system may employ a manual logging system, thereby allowing the media consumer to manually login data associated with the media consumer's purchases.

However, the media consumer may find the process of manually logging in purchases to be time consuming and burdensome. If the media consumer fails to manually log a purchase, the metering system may not be able to determine the effectiveness of the media.

Disclosed herein are systems and methods for correlating electronic mail (email) with media monitoring. The systems and method scan the email, determine if the email corresponds to a purchase receipt, and if the email corresponds to a purchase receipt, determines if a correlation exists between the purchased item associated with the purchase receipt and the consumed media associated with the purchaser.

The aspects disclosed herein may be implemented with any sort of media metering system, such as a web meter, a single panel source associated with a television, for example. Additionally, any sort of access to any personal email accounts must be expressly permitted by the user associated with the email. Further, the systems and methods may be implemented to anonymize the data associated with the correlation between an email receipt and consumed media. Thus, a monitoring service that receives information associated with the correlation may have no knowledge of any personal identifiable information (PII) associated with the media consumer.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that PII is removed. For example, a user's identity may be treated so that no PII can be determined for the user, or a user's geographic location may be generalized where location information is obtained (such as to a city, ZIP code, or state level), so that a particular location of a user cannot be determined. Thus, the user may have control over how information is collected about the user and used by a content server.

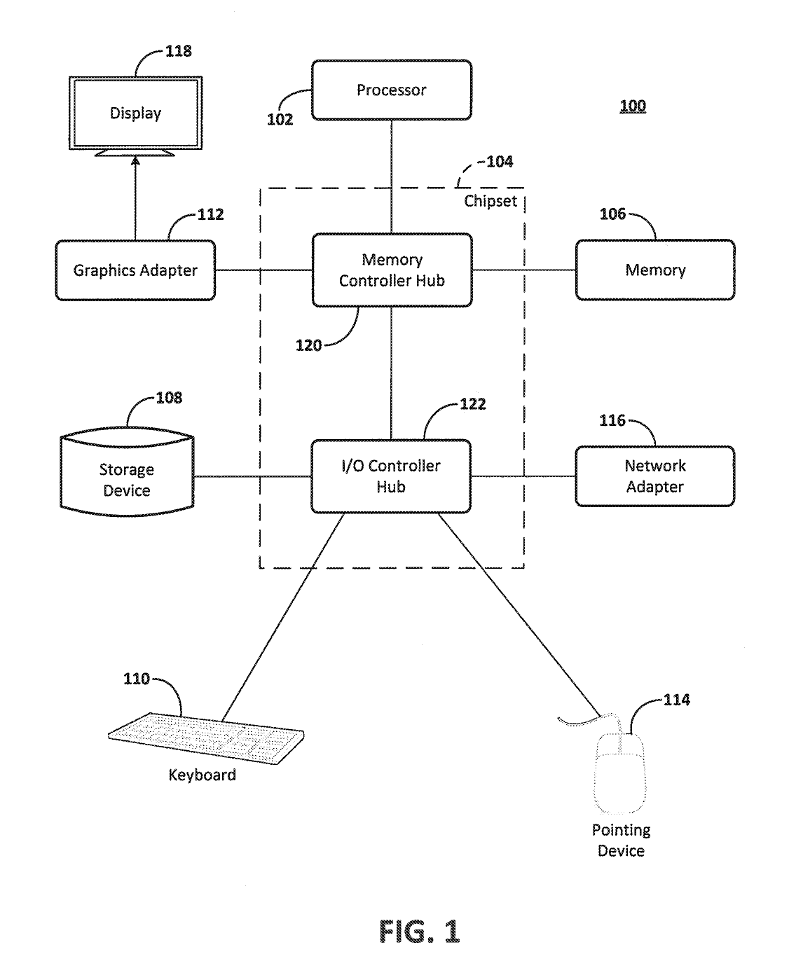

FIG. 1 is a diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer system 100. The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data store, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

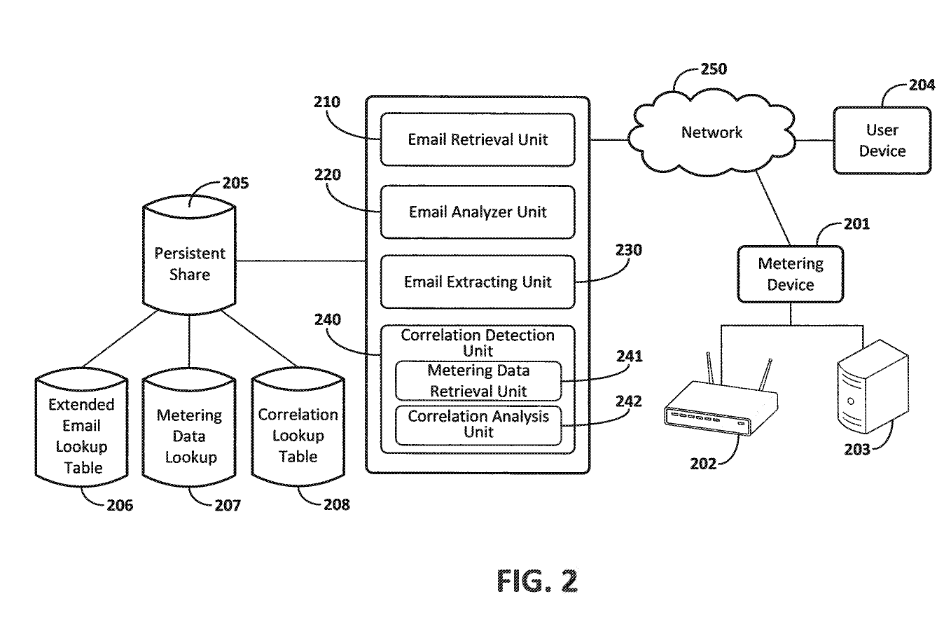

FIG. 2 illustrates an example of a system 200 for correlating email with media monitoring. The system 200 includes an email retrieval unit 210, an email analyzer unit 220, an email extracting unit 230, and a correlation detection unit 240. The system 200 may be implemented on a device such as computer 100. The system 200 may be incorporated as part of metering device 201. The metering device 201 may be any sort of media monitoring system that logs access to media consumption in association with a registered user.

A metering device 201, which may be implemented on a device such as computer 100, communicates with a router 202 or a computer server 203 to access a network 250. The network 250 provides access to an email service. The email service may be stored on an email server, may be incorporated as part of a user device 204, or implemented in software embedded in either the router 202 or the computer server 203. The metering device 201 may be implemented as part of or in communication with the router 202 or the computer server 203. Alternatively, the metering device 201 may be implemented as part of user device 204. The metering device 201 may be situated at a single source, such as in the proximity of a television or music playing device.

A persistent store 205 is a data storage device, such as the data store 108 described above. The persistent store 205 may be implemented along with system 200, or may be a stand-alone device. The persistent store 205 includes an email extraction lookup table 206, a metering data lookup table 207, and a correlation lookup table 208.

The email retrieval unit 210 retrieves email associated with a media consumer, with the media consumer giving express permission to do so. The email retrieval unit 210 may retrieve the email from an email service via network 250. The email retrieval unit 210 may retrieve the email from the media consumer's user device 204, or from any other location in which the media consumer's email may be stored. The email retrieval unit 210 may store the retrieved email in the persistent store 205.

The email analyzer unit 220 analyzes the retrieved email from the email retrieval unit 210 to determine if any of the emails correspond to a receipt of purchase from a seller of goods or services. The email analyzer unit 220 may search for certain words, phrases or formats to analyze the email. The email analyzer unit 220 then selects the emails that are determined to correspond to a receipt, and stores the selected emails in the persistent store 205.

A user associated with system 200 may create a list of stores in which the user does not want analyzed. Thus, if the email analyzer unit 220 detects that a receipt email is from a store on the list, the email analyzer unit 220 bypasses the analysis. In this way, the user may ensure that certain stores in which the user desires not to share information about is not communicated to a recipient of the data generated by system 200.

The email extracting unit 230 parses the selected emails from the email analyzer unit 220, and extracts relevant data from the purchase associated with the selective emails. The email extracting unit 230 may ascertain a name of the purchaser, an item or service being purchased, the location of the purchase, the purchase price, and a purchase time, for example. The email extracting unit 230 may store the ascertained data in the extracted email lookup table 206.

The correlation detection unit 240 includes a metering data retrieval unit 241 and a correlation analysis unit 242.

The metering data retrieval unit 241 retrieves data from the media consumer associated with the emails retrieved by the email retrieving unit 210 from the metering device 201. The metering data retrieval unit 241 also may retrieve data from a media consumer that matches an extracted name from the email extracting unit 230 from the metering device 201. For example, if person ‘B’ purchases an item, but emails the receipt to person ‘A’, the metering data retrieval unit 241 may retrieve data associated with person ‘B’ from the metering device 201. The metering data retrieval unit 241 may store the retrieved data in a metering data lookup table 207.

The correlation analysis unit 242 may determine if any data stored in the extracted email lookup table 206 matches any data stored in the metering data lookup table 207. For example, if person ‘A’ purchases a product ‘X’ (as indicated by the data in the extracted email lookup table 206), and person ‘A’ consumes media associated with product ‘X’, the correlation analysis unit 242 may determine that a correlation exists. The correlation analysis unit 242 may store the correlation in the correlation lookup table 208.

The correlation analysis unit 242, in determining a matching, may determine that attributes in the extracted email lookup table 206 and the metering data lookup table 207 are related, and thus correlated. For example, if person ‘A’ purchases product ‘X’, and person ‘A’ consumes media associated with product ‘Y’, the correlation analysis unit 242 may determine that product ‘X’ and product ‘Y’ are related (for example, are different soap brands). The correlation analysis unit 242 may store the correlation in the correlation lookup table 208 and indicate how the data items are related to each other.

The correlation analysis unit 242 may also indicate other relationships between the purchased data and the consumed media. For example, the correlation analysis unit 242 may indicate the time difference between when the media was consumed and when the purchase was made.

The correlation analysis unit 242 may also note if the media consumed led to a purchase being made online or led to the purchase being done at a physical location. The implementer of system 200 may determine if a condition for a correlation exists between the data stored in email extraction lookup table 206 and the data stored in the metering data lookup table 207, thereby triggering the storing of an entry in the correlation lookup table 208.

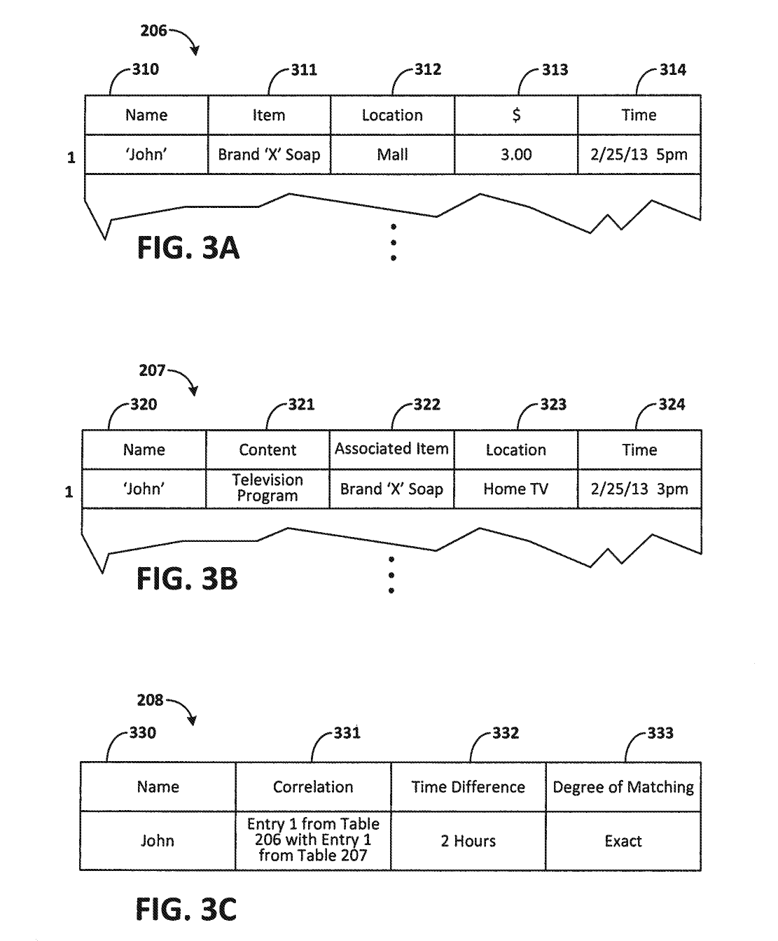

FIGS. 3(a)-(c) illustrate examples of an email extraction lookup table 206, a metering data lookup table 207, and a correlation lookup table 208, respectively.

The email extraction lookup table 206 illustrated in FIG. 3(a) includes a name field 310, an item field 311, a location field 312, a cost field 313, and a time field 314. A system 200 implementation may incorporate any combination of the above enumerated fields, or any data associated with an email receipt. As shown in FIG. 3(a), a sample entry for the email extraction lookup table 206 is presented.

The metering lookup table 207 illustrated in FIG. 3(b) includes a name field 320, a content field 321, an associated item field 322, a location field 323, and a time field 324. A system 200 implementation may incorporate any combination of the above enumerated fields, or any data associated with metering data.

The correlation lookup table 208 illustrated in FIG. 3(c) includes a name field 330, a correlation field 331, a time difference field 332, and a degree of matching 333. A system 200 implementation may incorporate any combination of the above enumerated fields, or any data associated with a correlation from the email extraction lookup table 206 and the metering lookup table 207.

As shown in FIG. 3(c), a correlation between entry 1 of the email extraction lookup table 206 and entry 1 of the metering lookup table 207 is stored. The correlation is made based on field 311 matching field 322 (i.e. Brand ‘X’ soap). Field 332 indicates that a difference in time a user ‘John’ viewed a program associated with Brand ‘X’ soap from the time the user ‘John’ purchased Brand ‘X’ soap is two hours. Field 333 stores a degree of matching between field 311 and field 322. As shown in the example in FIG. 3(c), the degree of matching is exact. However, if the user John purchases Brand ‘Y’ soap instead, the degree of matching may be listed as similar.

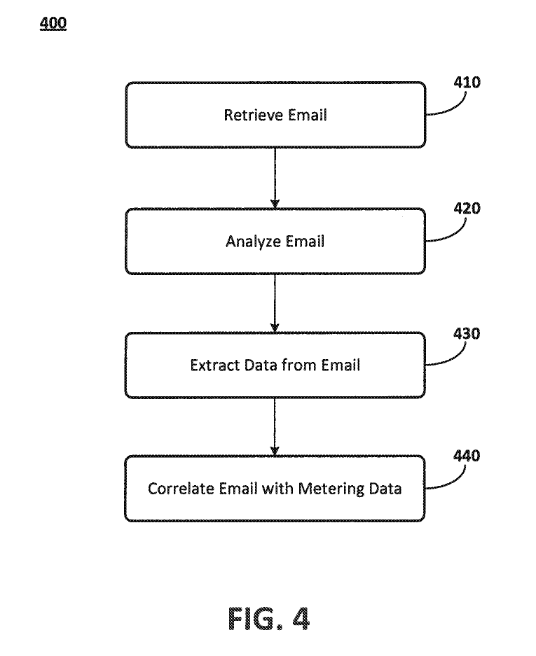

FIG. 4 illustrates an example of a method 400 for correlating email with media monitoring.

In operation 410, email retrieval is performed. For example, if a user (or group users) gives permission to access emails, in operation 410 the emails associated with the user (or group users) is retrieved. The user (or group of users) may give permission to access an email server and retrieve emails associated with the user (or group of users). Alternatively, the emails may be stored on a personal device associated with the user.

In operation 420, the email retrieved in operation 410 undergoes an analysis to determine if any of the emails pertain to receipts or acknowledgements associated with the purchase of goods or services. Thus, certain emails may be flagged and stored. The analysis performed in operation 420 may employ various text-based or information-based scanning techniques to determine if the email is a receipt. For example, the email may be scanned to determine if there is any text associated with a cost, a good, a store, a purchase time, and the like.

In operation 430, the emails analyzed in operation 420 and flagged as receipts undergo an extraction process. Thus, relevant data, such as the data associated with the email extraction lookup table 206 in FIG. 3(a), is extracted. In operation 430, a record of all the relevant data associated with a purchase of a good or service by a user is made.

In operation 440, a second database is analyzed pertaining to a record of media consumption performed by the user (or group of users) extracted in operation 430 who are associated with email receipts retrieved in operation 420.

In operation 440, correlations between a user's emails and the same user's media consumption habits may be made. For example, as illustrated in FIGS. 3(a)-(c), a determination may be made that a user who purchase brand ‘X’ consumed media associated with brand ‘X’ prior to the purchase. The correlations made in operation 440 may be stored in a database, such as correlation lookup table 208.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIG. 4. The disclosed devices, components, and systems contemplate using or implementing any suitable technique for performing the steps illustrated in these figures. Thus, FIG. 4 is for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

1. (canceled)

2. The system according to claim 21, wherein the email analyzer unit analyzes by scanning each of the plurality of emails for information pertaining to a good or service, a location, a purchase price, or text indicating that the scanned email is a purchase.

3. The system according to claim 21, wherein the media monitoring is performed by a metering device.

4. (canceled)

5. The system according to claim 21, wherein the plurality of emails are sourced from a user.

6. The system according to claim 21, wherein the plurality of emails are sourced from a plurality of users.

7. The system according to claim 6, wherein the metering device stores data associated with each of the plurality of users'monitored media consumption.

8. (canceled)

9. The system according to claim 21, wherein the correlation detection unit detects a time difference between the extracted relevant data and a time associated with the corresponding data from the media monitoring.

10. The system according to claim 21, wherein the correlation detection unit detects a similarity degree between the extracted relevant data and the corresponding data from the media monitoring.

11. (canceled)

12. The method according to claim 22, wherein the determination of which of the plurality of emails are a receipt is performed by scanning each of the plurality of emails for information pertaining to a good or service, a location, a purchase price, or text indicating that the scanned email is a purchase.

13. The method according to claim 22, wherein the media monitoring is performed by a metering device.

14. (canceled)

15. The method according to claim 22, wherein the plurality of emails are sourced from a user.

16. The method according to claim 22, wherein the plurality of emails are sourced from a plurality of users.

17. The method according to claim 16, wherein the metering device stores data associated with each of the plurality of users' monitored media consumption.

18. (canceled)

19. The method according to claim 22, further comprising determining a time difference between the extracted relevant data and a time associated with the corresponding data from the media monitoring.

20. The method according to claim 22, further comprising detecting a similarity degree between the extracted relevant data and the corresponding data from the media monitoring.

21. A system for correlating electronic mail (email) with media monitoring, comprising:
a device, comprising a data store comprising an email extraction lookup table, a metering lookup table, and a correlation lookup table, and a processor configured to execute an email retrieval unit, an email analyzer unit, an email extracting unit, and a correlation detection unit;
wherein the email retrieval unit is configured to retrieve a plurality of emails;
wherein the email analyzer unit is configured to analyze the plurality of emails to determine which of the plurality of emails are a receipt;
wherein the email extracting unit is configured to:
extract, from each of the plurality of emails that are analyzed as a receipt, an identification of a purchaser, an identification of a purchased item, and an identification of a purchase time, and
store, for each of the plurality of emails, the extracted identifications in the email extraction lookup table; and
wherein the correlation detection unit is configured to, for each entry stored in the email extraction lookup table:
compare the extracted identifications in said entry to one or more entries in the metering lookup table, each entry in the metering lookup table comprising an identification of a media consumer, an identification of an item associated with the consumed media, and an identification of a consumption time, and
store, in the correlation lookup table, an identification of each entry in the metering lookup table correlated with said entry in the email extraction lookup table.

22. A method implemented on a processor for correlating electronic mail (email) with media monitoring, comprising:
retrieving, by an email retrieval unit executed by a processor of a device, from a data store, a plurality of emails;
determining, by an email analyzer unit executed by the processor, which of the plurality of emails are a receipt;
extracting, by an email extracting unit executed by the processor, from each of the plurality of emails that are determined to be a receipt, an identification of a purchaser, an identification of a purchased item, and an identification of a purchase time;
storing, by the email extracting unit for each of the plurality of emails, the extracted identifications in an email extraction lookup table stored in the data store; and
for each entry stored in the email extraction lookup table:
comparing, by a correlation detection unit executed by the processor, the extracted identifications in said entry to one or more entries in the metering lookup table, each entry in a metering lookup table stored in the data store comprising an identification of a media consumer, an identification of an item associated with the consumed media, and an identification of a consumption time, and
storing, by the correlation detection unit in a correlation lookup table stored in the data store, an identification of each entry in the metering lookup table correlated with said entry in the email extraction lookup table.
